(19) United States
(12) Patent Application Publication
(10) Pub. No.: US 2005/0011378 A1
(43) Pub. Date: Jan. 20, 2005

(54) Audio producing stamping apparatus

(75) Inventors: Eric Thomas Shuler, Piedmont, CA (US); Kim Voskuil, Fremont, CA (US); Stuart Kurdi, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/745,930

(22) Filed: Dec. 26, 2003

Related U.S. Application Data
(60) Provisional application No. 60/436,723, filed on Dec. 27, 2002.

(51) Int. Cl. B41J 1/60

(52) U.S. Cl. 101/111

(57) ABSTRACT

The present invention provides a stamping apparatus with an audio feature thereby providing a “talking stamper” for entertainment or educational purposes. The talking stamper provides sounds for the user, particularly in response to a stamping action. The stamper has at least one raised indicium configured to form an imprint of the indicium on a sheet of material during the stamping action. In preferred embodiments, the indicium has the form of a letter of an alphabet or a picture of an object related to a letter of an alphabet. In these embodiments, the sounds provided to the user are related to the letter and/or object, including but not limited to a pronunciation of the letter, a phoneme of the letter, a sound related to the object, or a song.

### CROSS-REFERENCES TO RELATED APPLICATIONS

This application claims the benefit and priority of U.S. Provisional Patent Application No. 60/436,723, filed Dec. 27, 2002, the full disclosure of which is hereby incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates to the field of stamping devices, particularly to the field of handheld stamping toys for use in imprinting indicia, such as characters and designs, on a sheet of material. In addition, the present invention relates to the field of educational toys, particularly for use in teaching children language skills.

Children learn letters, numbers and the names of various objects by audible repetition accompanied with visualization of the object. Often, a parent or teacher will read a book aloud while pointing to the object depicted by the word which is read. In this way, the child is able to visually associate the object with its name. This method of teaching is generally passive, i.e., there may be little interaction between the child and subject matter. Interactive teaching methods using multiple sensory perceptions are more effective than mere memorization.

It is known that voice synthesizers are used as communication devices for disabled adults. One such example is described in Medical & Biological Engineering and Computing, January 1979, titled “Verbal Communication Aid for Non-Vocal Patients.” This article describes a voice synthesizer to speed communication for speech impaired patients. Each device includes a keyboard networked via a commercial telephone by a wire connection to a central voice generating system. The use of the central system permits many individual boards to employ a single-control unit, thereby reducing the total cost of each device. In this way, a number of boards in a single geographic area can utilize the same control unit.

This device may additionally be used as a teaching or translation aid for children. In such an application, the keys are covered with letters or numbers and, when depressed, produce a voice response. This device is advantageous in that a child may use the device interactively alone, without close supervision. The parent or teacher can then attend to other matters. However, the keys are substantially identical, the differences appearing only in a typed letter on each key.

An article title “μ C-Based Key-to-Speech Synthesizer Gives Stroke Victims A Voice” (EDN Desion News Feb. 20, 1978) by Sam Davis discloses a system for producing the basic sounds of speech. Each spoken word is broken into phonemes to simulate a word. This system uses phonemic command words to control a synthesizer. Other devices use voice synthesis devices for various purposes. U.S. Pat. Nos. 4,357,489 to Henderson, et al., assigned to Texas Instruments Incorporated, and U.S. Pat. No. 4,689,817 to Kroon each disclose an integrated circuit for synthesizing speech. U.S. Pat. No. 4,646,350 to Batra employs such an integrated circuit in a child's shoe to provide an audible message when opening of closing the shoe.

Prior art devices, however, fail to provide meaningful visual indicia attractive to children which can facilitate learning when incorporating voice synthesis devices. The device described herein provides many advantages over prior art devices in such a way as to invite interaction with children and facilitate the learning process for speaking, reading and memorization.

### BRIEF SUMMARY OF THE INVENTION

The present invention provides a stamping apparatus with an audio feature thereby providing a “talking stamper” for entertainment or educational purposes. The talking stamper provides sounds for the user, particularly in response to a stamping action. The stamper has at least one raised indicium configured to form an imprint of the indicium on a sheet of material during the stamping action. In preferred embodiments, the indicium has the form of a letter of an alphabet or a picture of an object related to a letter of an alphabet. In these embodiments, the sounds provided to the user are related to the letter and/or object, including but not limited to a pronunciation of the letter, a phoneme of the letter, a sound related to the object, or a song. In this way, the stamper is used to teach concepts in the areas of graphophonemic knowledge and phonemic awareness by improving skills related to letters, letter sounds, letter/object association and vocabulary. In addition, the stamper offers object-handling activities for children that help improve motor control, precision and accuracy of movement which are foundational skills for future small-motor skills. Further, the stamper provides an opportunity for creative play and entertainment.

In preferred embodiments, the talking stamper allows a child to stamp out letters and/or pictures with the use of an ink pad while learning letter names and sounds. In these embodiments, the stamper has at least one stamping structure bearing 26 letters of the alphabet and 26 associated pictures of objects, wherein the name of each object starts with the corresponding letter of the alphabet (i.e., A, ant). On the side of the stamper, there is a selection dial that allows the child to select one of the 26 letters of the alphabet, one of the 26 pictures, or both. Near the bottom of the stamper, there is a mode switch that allows the child to choose between at least three play modes. To select a one of the 26 letters, the mode switch is changed to the Letter Mode. When the Letter Mode is selected, the stamper may say “Let's stamp letters!” and a melody may play quietly in the background. When the selection dial is rotated, the letters are called out, “A, B, C, D, E, etc.!”. This audio is preferably interruptable so that the child may hear bits and pieces of the beginnings of different letters as the dial is rotated. Selection of a desired letter positions the indicium of the desired letter at the bottom of the stamper and the associated picture of the object is covered. Upon such selection, the stamper may provide additional sounds, such as “B says Buh!”. A stamping action creates an imprint of the selected letter on a sheet of material, preferably a sheet of paper. In addition, each stamping action causes the stamper to make a sound such as “B!”.

To select a one of the 26 pictures of objects, the mode switch is changed to the Object Mode. When the Object Mode is selected, the stamper may say “Let's stamp pictures! ” and a background beat may play quietly in the background. When the selection dial is rotated, the names of the pictures are called out, “Apple, Ball, Cat, etc.!”. This audio is preferably interruptable so that the child may hear bits and pieces of the beginnings of different object names as the dial is rotated. Selection of a desired object positions the indicium of the desired object at the bottom of the stamper and the associated letter is covered. Upon such selection, the unit may provide additional sounds, such as “Ball starts with the letter B! ”. A stamping action creates an imprint of the selected picture. In addition, each stamping action causes the stamper to make a sound such as “Ball!”.

To select a pair of one of the 26 letters and 26 associated pictures of objects, the mode switch is changed to the Song Mode. When the Song Mode is selected, the stamper may say “Let's stamp and sing! ”. The desired pair is selected by rotating the selection dial. Selection of a desired pair positions the indicia of the desired pair at the bottom of the stamper and neither of the indicia are covered. The stamper may play a song, such as Old MacDonald. The song may prompt the child to stamp a letter and object pair and once stamped the stamper may insert audio for that letter into the song.

The above described activities teach letter names and phonemes, teach the beginning sounds of words, corresponds letter names and phonemes to stamped upper case letters, corresponds a word to a stamped picture and reinforces phonemes throughout songs, to name a few. In addition, the talking stamper is fun to use for entertainment and play.

It may be appreciated that the talking stamper is not limited to the indicia used in the above example. Any indicia may be used, such as any graphical representations, printed indicia or numerical representations, or any combination thereof. Likewise, any number of stamping structures may be present bearing any number of raised indicia. The indicia may be constant or selectable, in any combination or arrangement. In addition, other objects and advantages of the present invention will become apparent from the detailed description to follow, together with the accompanying drawings.

### BRIEF DESCRIPTION OF THE DRAWINGS

FIG. 1 provides a schematic illustration of an embodiment of the stamping apparatus of the present invention.

FIG. 1A illustrates a bottom view of the stamping apparatus of FIG. 1.

FIG. 1B illustrates an imprint of indicia on a sheet of material.

FIG. 1C illustrates a front view of the stamping apparatus of FIG. 1, including a selection dial.

FIG. 2 illustrates a plurality of example indicia of the present invention.

FIG. 3 illustrates an embodiment of the stamping apparatus having two stamping structures comprising belts.

FIG. 4 illustrates a cross-sectional view of the stamping apparatus of FIG. 3.

FIG. 5 illustrates a side view of the stamping apparatus showing a speaker.

FIGS. 5A-5B illustrate cross-sectional views of the apparatus of FIG. 5.

FIGS. 6-6A illustrate examples of processor circuitry employed in the stamping apparatus of FIG. 1.

FIG. 7 is a functional block diagram of synthesizing circuitry of the present invention.

FIGS. 8-9 illustrate example activity pages optionally provided with the stamping apparatus of the present invention.

### DETAILED DESCRIPTION OF THE INVENTION

Description of Stamping Apparatus

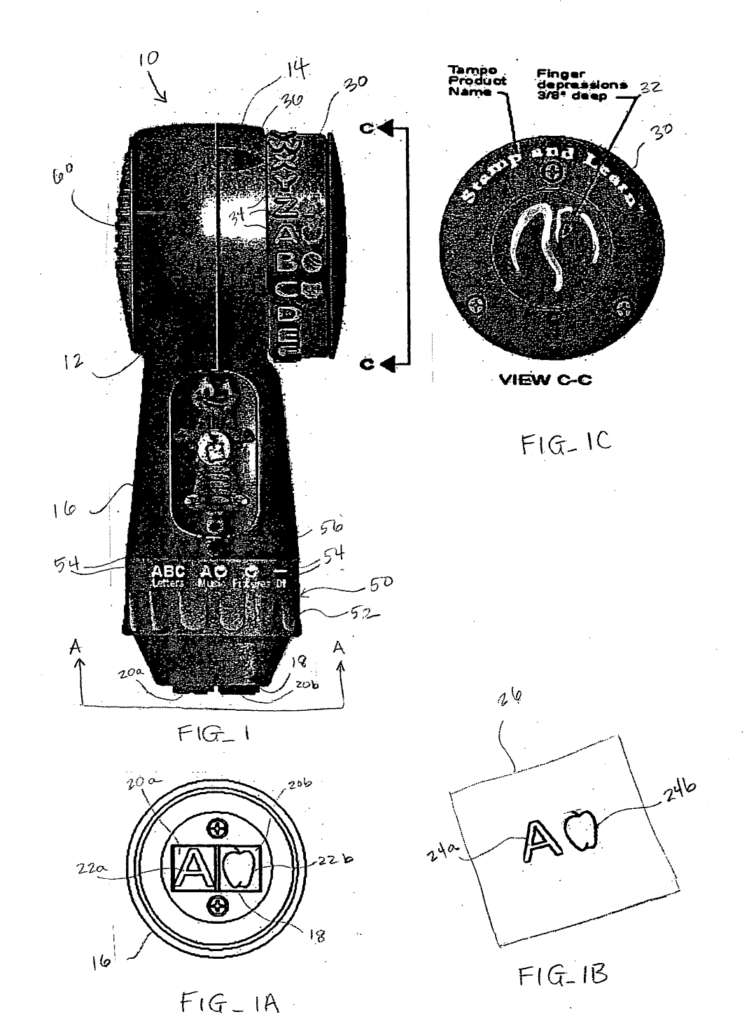

FIG. 1 provides a schematic illustration of an embodiment of the stamping apparatus 10 of the present invention. In this embodiment, the stamping apparatus 10 comprises a plastic housing 12 having a top portion 14 and a bottom portion 16. The bottom portion 16 is configured for gripping the stamping apparatus 10 by a hand of a user during a stamping action. Thus, it has a generally cylindrical shape with an orifice 18 at its end through which at least one stamping structure 20 protrudes. In this embodiment, portions of two stamping structures 20a, 20b are shown protruding through the orifice 18. FIG. 1A provides a bottom view of the apparatus 10 illustrating the stamping structures 20a, 20b. As shown, each stamping structure 20a, 20b, has at least one raised indicium 22a, 22b, respectively. In this example, raised indicium 22a has the form of the letter A and raised indicium 22b has the form of an apple. The raised indicia 22a, 22b are each configured to form an imprint 24a, 24b, respectively, on a sheet of material 26, as shown in FIG. 1B, by means of a stamping action. A stamping action involves pressing the protruding stamping structures 20a, 20b against an inking surface, such as an ink pad, so that ink is transferred to the raised indicia 22a, 22b, removing the structures 20a, 20b from the inking surface and pressing the stamping structures 20a, 20b against a sheet of material 26, such as paper, so that the ink on the raised indicia 22a, 22b is transferred to the material 26 leaving imprints 24a, 24b.

In this embodiment, the raised indicia 22a, 22b are selectable by the user. Thus, the stamping apparatus 10 includes a dial 30 within its top portion 14 for selecting the desired indicium or indicia, in this example indicia 22a, 22b. FIG. 1C illustrates a front-view of the dial 30. As shown, the dial 30 may include at least one finger depression 32 to assist in turning the dial 30 by the hand of the user. Indicium representations 34 are disposed around the dial 30 to allow selection of the desired indicium or indicia. The dial 30 is rotated until the desired indicium representation 34 is aligned with arrow 36. Rotation of the dial 30 actuates a mechanism to select the appropriate indicium 22 which corresponds with the indicium representation 34, positioning the selected indicium 22 through the orifice 18 for stamping.

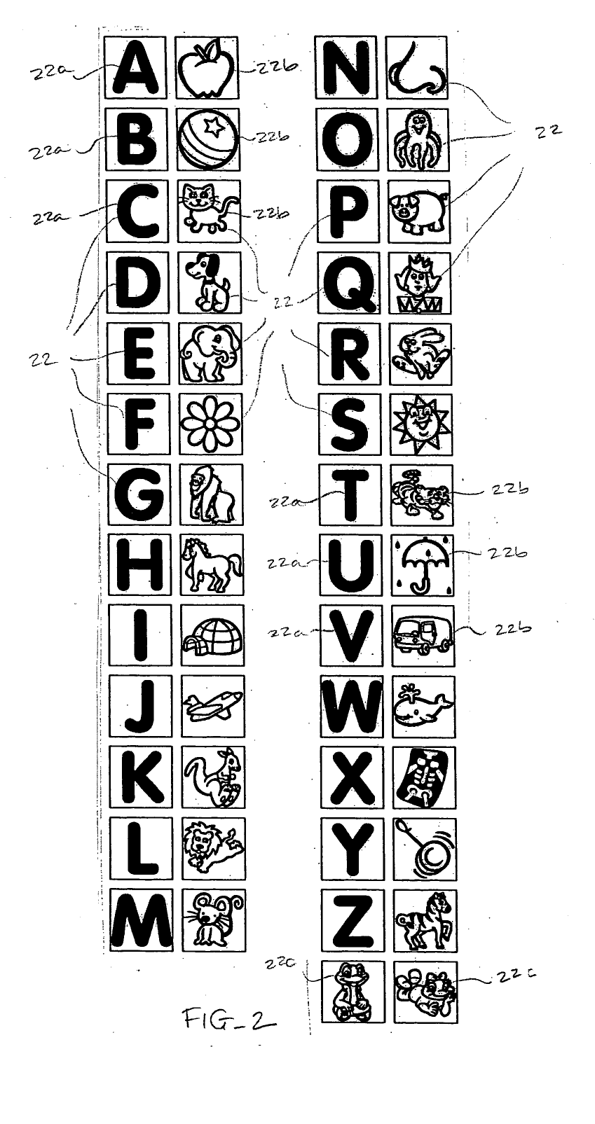

FIG. 2 illustrates a plurality of example indicia 22. Here, the indicia 22 are provided in pairs. A pair includes a first indicium 22a, such as a letter of the alphabet, and a second indicium 22b, such as a picture of an object associated with the letter. For example, the first indicium 22a may have the form of a letter A and the second indicium 22b may have the form of a picture of an apple. Likewise, the first indicium 22a may have the form of a letter B and the second indicium 22b may have the form of a picture of a ball. Thus, FIG. 2 illustrates 26 pairs of indicia 22 corresponding to the English alphabet and related objects. In this embodiment, an additional 27th pair is provided to allow selection of an additional pair of indicia 22c, such as pictures of characters, as shown. The additional 27th pair may alternatively be used to provide letters, symbols or other shapes used in other alphabets, such as the Spanish alphabet.

Again, it may be appreciated that although the indicia include letters and pictures in the preferred embodiments, the indicia can have any suitable form. For example, the indicia may comprise numbers, symbols, shapes, designs, graphical representations or any combination thereof.

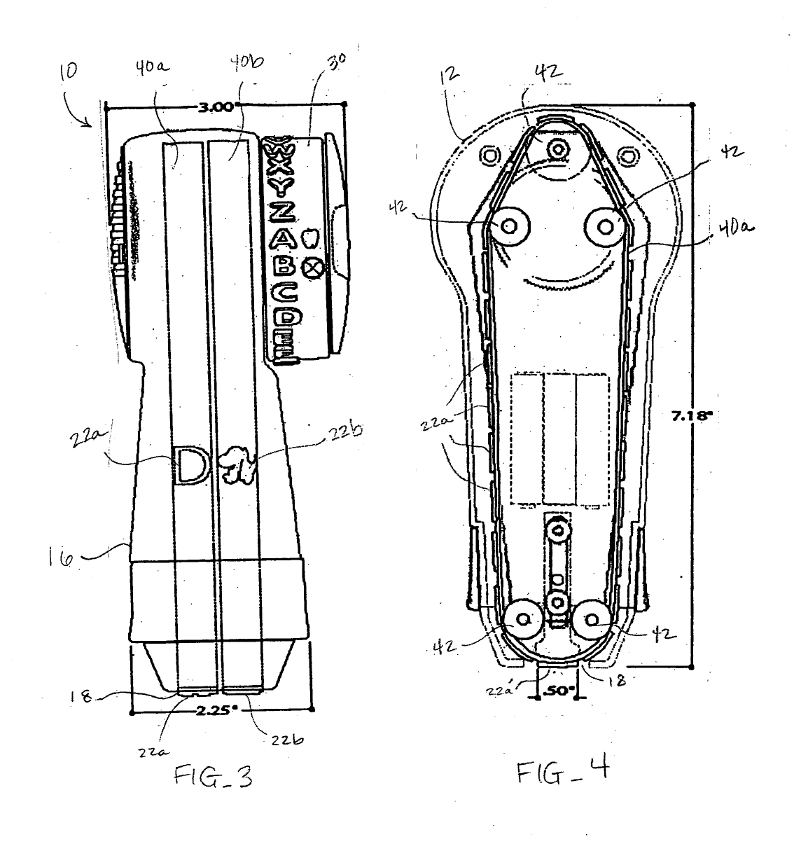

The plurality of indicia 22 may be disposed on the stamping structure 20 in any suitable arrangement. In preferred embodiments, the stamping structure 20 comprises a belt 40 and the plurality of indicia 22 are disposed sequentially along the belt 40. FIG. 3 illustrates an embodiment of the stamping apparatus 10 including two belts 40a, 40b, each belt having a portion of the plurality of indicia 22 disposed thereon. As schematically shown, one of the belts 40a has the set of first indicia 22a illustrated in FIG. 2 (i.e. letters of the alphabet) and the other belt 40b has the set of second indicia 22b illustrated in FIG. 2 (pictures of associated objects). Such indicia 22a, 22b are disposed sequentially along the belts 40a, 40b, respectively, so that a pair of such indicia 22a, 22b protrude through at least one orifice 18 at the end of the bottom portion 16.

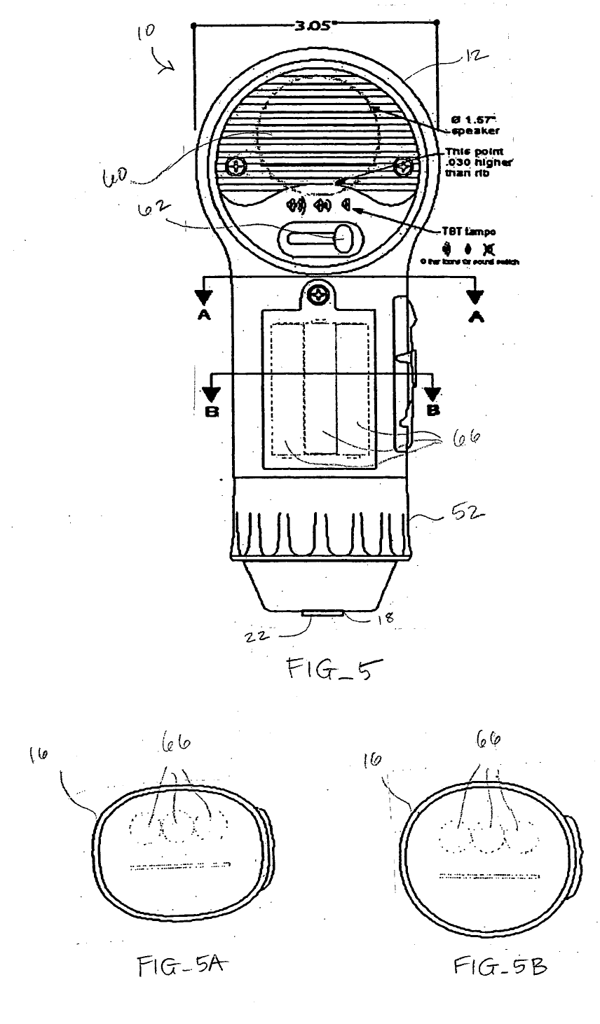

FIG. 4 provides a cross-sectional view of the stamping apparatus 10 of FIG. 3 showing one of the belts 40a within the housing 12. As shown, the set of first indicia 22a are disposed along the belt 40a. The belt 40a is mounted on a series of rollers 42 so that rotation of the dial 30 rotates the belt 40, positioning the desired indicia 22a′ within the orifice 18.

It may be appreciated that the stamping apparatus 10 of the present invention may have a single stamping structure 20 which provides a single raised indicium 22 for stamping action. For example, the stamping structure 20 may comprise a planar rubber slab having a single raised indicium thereon. The rubber slab may be stationary or may simply move up and down in some embodiments, for example. Alternatively, the stamping apparatus 10 may have a single stamping structure 20 and a plurality of raised indicia 22 which are selectable. For example, the stamping structure 20 may comprise a single belt having a plurality of raised indicia 22 positioned sequentially thereon. The belt may have only letters or only numbers, for example. Or, more than one stamping structure 20 may be present, each having a single raised indicium 22 or a plurality of raised indicia 22, wherein the stamping structure 20 and/or the indicia 22 may be independently or dependently selectable. Such selection will be further described in the “Modes of Play” section.

It may be appreciated that various modifications to the stamping apparatus 10 are possible. For example, the preferred stamping apparatus described herein uses a separate ink pad to provide ink to the stamping structure. In other embodiments, an ink reservoir may be provided in the stamping apparatus 10 using the known technology of self-inking stampers.

Audio

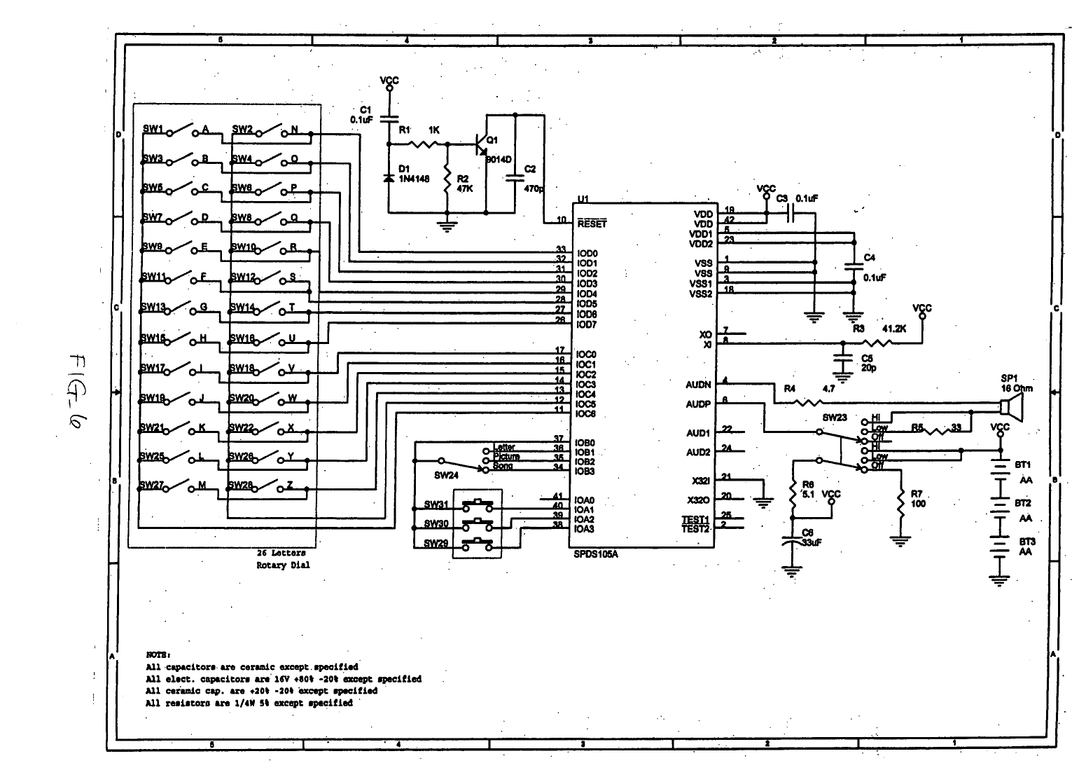

Although the stamping apparatus 10 may be used as a mechanical stamping device without audio, the audio portion of the “talking stamper” provides a desirable aspect of the present invention. The stamping apparatus 10 includes a processor, a sound generator coupled to the processor and a speaker operatively connected to the processor wherein the sound generator and speaker are capable of producing audio. Referring back to FIG. 1, in preferred embodiments the speaker 60 is positioned near the top portion 14 of the housing 12, opposite the dial 30. FIG. 5 provides a side view of the stamping apparatus 10, illustrating the speaker 60 within the housing 12. In addition, a volume switch 62 is provided near the speaker 60 to allow the user to adjust the volume of the audio emanating from the speaker 60. The volume switch 62 can be set to a variety of volume settings including HIGH, LOW, and MUTE. FIG. 5A provides a cross-sectional view along A-A of bottom portion 16 and FIG. 5B provides a cross-sectional view along B-B of bottom portion 16; differences in shape and diameter can be seen. Typically, batteries 66 are positioned within the bottom portion 16 of the stamping apparatus 10 which may limit the minimum diameter of the bottom portion 16. However, the diameter may be reduced, such as along A-A, to assist small children in grasping the bottom portion 16 for stamping action.

The audio that is produced by the stamping apparatus 10 may relate to the indicia 22 in any suitable manner. For example, in some embodiments, the audio may relate to the color, size, character, or name of an indicum 22 being stamped. The audio may also be in the form of the English language and/or may include one or more foreign languages such as Spanish, Japanese, German, etc. If the indicia 22 comprise letters or phonemes, the sounds associated with the letters or phonemes may be produced by the stamping apparatus 10. Phonemes are discussed in detail in U.S. Pat. No. 5,188,533, which is herein incorporated by reference in its entirety.

The processor circuitry utilized in a preferred embodiment of the invention will now be described. The following implementation is but one of many possible implementations, as is readily apparent to those skilled in the art. The following circuitry is for illustrative purposes only. Similar circuitry, suitably modified, may be employed in other embodiments of the present invention, but such circuitry should not be viewed as limiting the invention, as numerous other electronic implementations may be employed by one skilled in the art without departing from the scope of the invention as disclosed, taught and claimed herein.

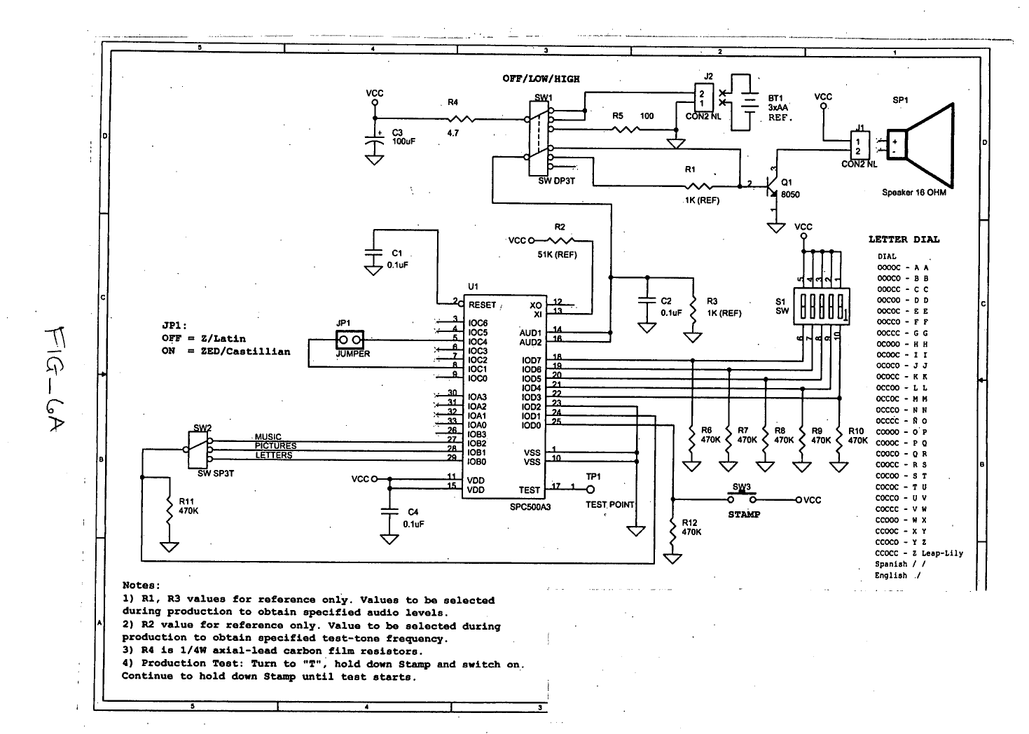

Turning attention now to FIGS. 6, 6A, example processor circuitry employed in the FIG. 1 embodiment of the present invention are shown. As illustrated in FIG. 6, an SPDS105A chip, commercially available from SunPlus Technologies Co., Ltd. can be used. This chip includes a microprocessor and a digital signal processor for long audio applications. FIG. 6 also shows that 26 different switches can be used for the 26 different letters of the alphabet. As illustrated in FIG. 6A, alternatively, an SPC500A3 chip, also commercially available from SunPlus Technologies Co., Ltd. could be used. In comparison to FIG. 6, FIG. 6A shows that a coding scheme using 5 switches can be used to identify the 26 letters of the alphabet. Either of the mentioned chips may provide for speech synthesis. As an alternative, a voice synthesizer chip commercially available from Texas Instruments could be used. In general, however any type of circuitry or chip may be employed. Furthermore, the circuitry may be modified by a skilled artisan to incorporate other features described and taught herein.

The chip or chips that are used may comprise an integrated circuit speech synthesis system (for example the device taught in U.S. Pat. No. 4,357,489 to Henderson, et al. as developed by Texas Instruments Incorporated, or suitable alternative). Many speech synthesis integrated circuits are presently commercially available in a wide variety of configurations, and are well known in the art. The variations between available synthesis chips include the amount of memory for synthesis information stored which is used to provide an output signal in the form of a frequency used to drive a speaker. The output signal can be long or short as necessary for the particular application.

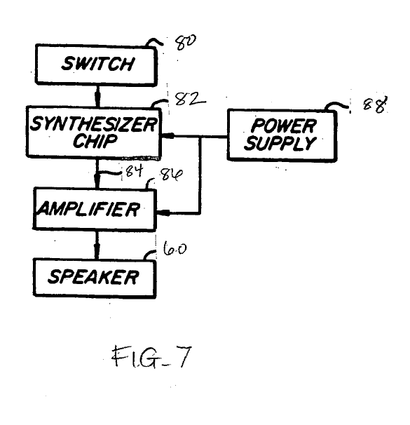

Referring now to FIG. 7, a functional block diagram of the synthesizing circuitry is illustrated. A functional block diagram is provided for simplicity, it being understood that one of ordinary skill will appreciate that a wide variety of electrical configurations can be used to provide the function herein described. Switch 80 is used to activate synthesizer chip 82 producing an output signal 84 which is amplified by amplifier 86 before driving speaker 60. Power supply 88 is electrically coupled to chip 82 and amplifier 86 to provide necessary current and voltage. In the preferred embodiment, power supply 88 is one or more batteries, such as batteries 66, but can have an alternative form such as a solar power device, a conventional wall outlet with transformer or other source of electrical energy.

It should be noted that the functional block diagram of FIG. 7 can be implemented by hardware devices which integrate some functions. For example, the hardware of amplifier 86 can be combined with the hardware of chip 82 or of speaker 60 in an integrated package if desired. Several commercial devices providing such packages could be used if desired. Likewise, switch 80 can be of many forms. Preferably, switch 80 is configured as to be sensitive to force on the stamping structure 20, such as during a stamping action, and/or to a mode switch change, as will be described in the “Modes of Play” section.

Modes of Play

The audio portion of the “talking stamper” is provided through at least one play mode, preferably a plurality of play modes. Referring back to FIG. 1, in a preferred embodiment, the stamping apparatus 10 includes a mode switch 50 which is used to select one of a variety of play modes. In this embodiment, four play modes are available and the mode switch 50 to switch between the modes includes a rotating ring 52 near the bottom portion 16 of the housing 12. A plurality of mode markers 54 are present on the ring 52, each marker 54 designating an associated play mode. Rotation of the ring 52 by the user and alignment of a desired mode marker 54 with a marker 56 on the bottom portion 16 of the housing 12, actuates the mode switch 50 to select the desired mode of play.

Here, the mode switch 50 allows the user to change between four modes of play. When the ring 52 is positioned to select the first mode, rotation of the dial 30 allows the user to select a first indicia 22a from the first belt 40a. In a preferred embodiment, wherein the first indicia 22a are letters of the alphabet, the first mode is the “Letter Mode”. In some embodiments, selection of the first mode will cause the speaker to produce a sound. In the preferred embodiment, the sound from the speaker may include, “Let's stamp letters!” Alternatively or in addition, a melody or Letter Mode Intro Jingle may play which may optionally continue quietly in the background throughout the use of the Letter Mode.

While in the Letter Mode, rotation of the dial 30 selects a letter for stamping (i.e. positions the desired first indicia 22a within the orifice 18). Turning the dial 30 passes each indicium representation 34 or letter by arrow 36 on housing 12. The speaker may produce a different sound as each letter passes, such as a pronunciation of the passing letter. This audio is heard almost immediately upon reaching a letter on dial 30. For example, as the dial 30 is turned, “A, B, C, D, E, etc!” is heard. If the dial 30 pauses on a letter, such as for 1 second time, an alternate audio may be produced, such as a phoneme of the letter. For example, pausing on the letter “B” may produce an audio of “B says Buh”. The user may then make a stamping action. Each time the user makes a stamping action, the audio may be repeated, “B says Buh”, the pronunciation of the letter may be heard, “B!”, or another audio may be heard. In addition, if the letter has multiple phonemes, audio may be heard for each phoneme, such as “Letter A says Long-A and Short-A”. It may be appreciated that a variety of different audio sequence may be provided for each letter as described in Provisional Patent Application No. 60/436,723, incorporated herein by reference for all purposes.

When the ring 52 is positioned to select the second mode, rotation of the dial 30 allows the user to select a second indicia 22b from the second belt 40b. In a preferred embodiment, wherein the second indicia 22b are pictures of object related to letters of the alphabet, the second mode is the “Object Mode”. In some embodiments, selection of the second mode will cause the speaker to produce a sound. In the preferred embodiment, the sound from the speaker may include, “Let's stamp pictures!” Alternatively or in addition, a melody or Object Mode Intro Jingle may play which may optionally continue quietly in the background throughout the use of the Object Mode.

While in the Object Mode, rotation of the dial 30 selects an object for stamping (i.e. positions the desired second indicia 22b within the orifice 18). Turning the dial 30 passes each indicium representation 34 or object by arrow 36 on housing 12. The speaker may produce a different sound as each object passes, such as a pronunciation of the name of the passing object. This audio is heard almost immediately upon reaching a object on dial 30. If the dial 30 pauses on a object, such as for 1 second time, an alternate audio may be produced. For example, pausing on the object “Dog” may produce an audio of “Dog starts with the letter D”. The user may then make a stamping action. Each time the user makes a stamping action, the audio may be repeated, “Dog starts with the letter D”, or another audio may be heard, such as “Ruff! Ruff!” or “Dog!”. It may be that appreciated a variety of different audio sequences may be provided for each object as described in Provisional Patent Application No. 60/436,723, incorporated herein by reference for all purposes.

When the ring 52 is positioned to select the third mode, rotation of the dial 30 allows the user to simultaneously select a first indicia 22a and a second indicia 22b from the first belt 40a and second belt 40b, respectively. In a preferred embodiment, wherein the first indicia 22a are letters and the second indicia 22b are pictures of object related to the letters, the third mode is the “Song Mode”. In some embodiments, selection of the third mode will cause the speaker to produce a sound. In a preferred embodiment, the sound from the speaker may include, “Let's stamp and sing!”.

While in the Song Mode, rotation of the dial 30 selects a pair (a letter and an associated object) for stamping (i.e. positions the desired indicia 22a, 22b within the orifice 18). Turning the dial 30 passes each indicium representation 34 by arrow 36 on housing 12. The speaker may produce a different sound as each pair passes, such as a pronunciation of the passing letter and the name of the passing object, such as “B! Ball!”. This audio is heard almost immediately upon reaching a object on dial 30. If the dial 30 pauses on a object, such as for 1 second time, an alternate audio may be produced. For example, pausing on the pair of this example may produce an audio of song intro music and “B! Ball!”. The music may continue for approximately 8 seconds. The user may then make a stamping action. The first time the user makes a stamping action, the audio may provide part 1 of a song background music, a narrative such as “B! B! Ball!, children's singing voices such as “Starts with the letter.” and additional narrative such as “B!”, to name a few. A second stamping action may provide alternative audio, such as part 2 of a song background music, children's singing voices such as “Every letter makes a sound.”, narrative such as “B! B!” and additional children's voices such as “Stamp it!”, to name a few. A third stamping action may provide yet further alternative audio, such as part 3 of a song background music, a sound such as “Boing!” and narrative such as “Ball!”, to name a few. It may be appreciated that a different audio sequence is provided for each pair as described in Provisional Patent Application No. 60/436,723, incorporated herein by reference for all purposes. Alternatively or in addition, selection of the Song Mode may produce a song such as “Old MacDonald”. The song may prompt the user to stamp a pair and once the pair is stamped audio related to the pair may be inserted into the song. Thus, the song would continue to play throughout selection of a given pair.

When the ring 52 is positioned to select the fourth mode, the audio portion of the stamping apparatus 10 is turned OFF. Once in the OFF position, the audio may be turned on by switching to another mode. Alternatively, the audio may shut off by a time-out mechanism which is actuated if the stamping apparatus 10 is not touched for a designated amount of time or if the volume switch is changed to MUTE. The audio can be turned on when the time-out mechanism has been actuated by switching to a mode other than OFF, rotating the dial 30, switching the volume to LOW or HIGH, or making a stamping action, to name a few.

It may be appreciated that any of the modes of play or functions described herein can be programmed into the stamping apparatus by those of ordinary skill in the art.

Dimensions

The stamping apparatus 10 may have any suitable dimensions for a handheld device. Example dimensions for the housing 12 are approximately 7 inches in length, approximately 3 inches in width near the top portion 14 and approximately 2.25 inches in width near the bottom portion 16. Narrower widths, preferably 1.5 inches, near the bottom portion 16 are preferred to assist in grasping by small children. In some embodiments, the orifice 18 is approximately 0.5 inch×0.5 inch in size to allow approximately a 0.5 inch×0.5 inch portion of a stamping structure 20 to protrude therethrough. And, typical speakers have approximately a 1.25 to 2 inch diameter.

Accessories

Although the stamping apparatus 10 may be used by itself to create imprints on any suitable material, the apparatus 10 may be provided in a system with additional accessories. A few examples of such accessories are provided below:

Ink Pad

Any conventional ink pad may be used with and provided with the stamping apparatus 10. These conventional ink pads vary in size and are typically contained in plastic or metal containers with a closure lid to prevent the ink from drying out when the pad is not in use. These pads are usually formed of cotton felt and then enclosed with a thin fabric of cotton or linen.

Preferred ink pads for use with the stamping apparatus 10 have a container that is about 3″×2.5″ in size, dries within approximately 5 seconds, is non-smearing, washable and non-toxic. The ink pads may have one or more ink colors of any color, however blue and green ink are preferred.

Activity Pages

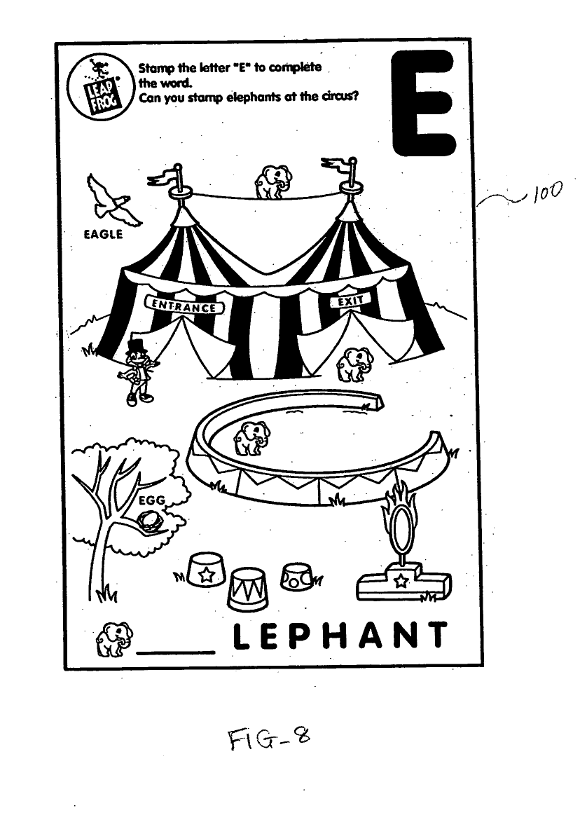

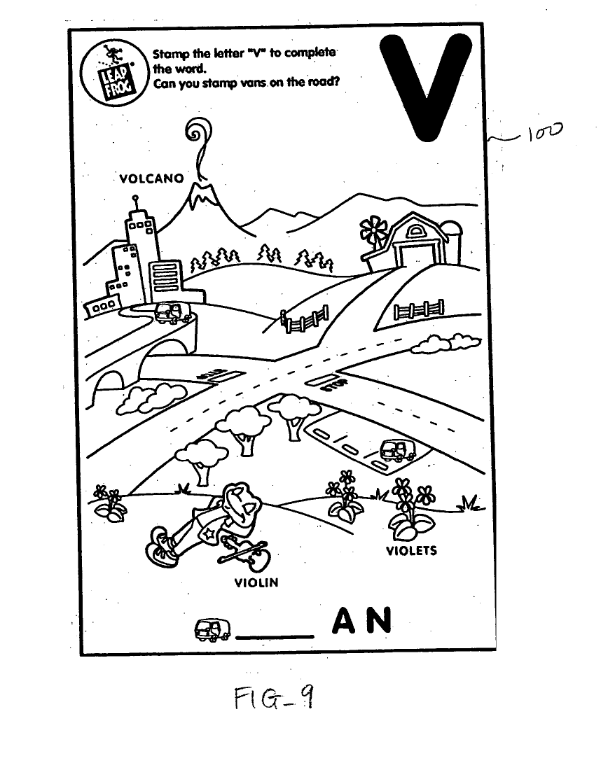

One or more activity pages may be provided for use with the stamping apparatus 10. FIGS. 8-9 provide illustrations of example activity pages 100. Typically, an activity page 100 will show a letter of the alphabet and images that start with the letter. For example, FIG. 8 shows the letter E and provides images of Elephants, an Eagle, an Egg, an Entrance sign and an Exit sign, to name a few. Further the activity page 100 may include a word which is missing the letter of the alphabet that the page 100 is designated for. For example, FIG. 8 shows the word _LEPHANT with the letter E missing. This allows the user to stamp the letter E in the blank with the stamping apparatus 10. There are also blank areas within the page for the user to stamp the associated object with the stamping apparatus 10, such as an elephant in this example. Similarly, FIG. 9 shows the letter V and provides images of Violets, a Volcano, and a Violin, to name a few. Further, FIG. 9 shows the word _AN with the letter V missing. This allows the user to stamp the letter V in the blank with the stamping apparatus 10. There are also blank roads within the page for the user to stamp the associated object (a van in this example) with the stamping apparatus 10.

The activity pages 100 may be provided singularly or bound in a book or booklet. In some embodiments, the pages 100 are arranged so that when the booklet is spread open, one side of the spread will show the activity page 100 and the other side of the spread will be blank so that the child can free-play stamping letters and/or objects throughout the page. When closed, the booklet's dimensions are preferably approximately 4.5″×8.5″.

Alternatively or in addition, the activity pages 100 may be provided on a website. The pages 100 can then be printed on a personal printer so that the child can do the activities again and again. In addition, newly updated activity pages 100 can be continuously provided.

Any features of any embodiments may be combined with features of other embodiments without departing from the scope of the invention. For example, the above described ink pad and/or activity pages may be combined in a system with any of the above described stamping apparatuses without departing from the scope of the invention.

Although the foregoing invention has been described in some detail by way of illustration and example, for purposes of clarity of understanding, it will be obvious that various alternatives, modifications and equivalents may be used and the above description should not be taken as limiting in scope of the invention which is defined by the appended claims. In addition, all publications and patent applications cited in this specification are herein incorporated by reference as if each individual publication or patent application were specifically and individually indicated to be incorporated by reference.

1. A stamping apparatus comprising:
at least one stamping structure having at least one raised indicium configured to form an imprint of the indicium on a sheet of material;
a processor;
a sound generator coupled to the processor; and
a speaker operatively connected to the processor, wherein the sound generator and speaker are capable of producing audio related to the indicium.

2. The apparatus of claim 1, wherein the at least one raised indicium has the form of a letter of an alphabet.

3. The apparatus of claim 2, wherein the audio produced by the speaker includes a sound related to the letter.

4. The apparatus of claim 3, wherein the sound includes a pronunciation of the letter and/or a phoneme of the letter.

5. The apparatus of claim 1, wherein the at least one raised indicium has the form of a picture of an object.

6. The apparatus of claim 5, wherein the audio produced by the speaker includes a sound related to the object.

7. The apparatus of claim 6, wherein the sound includes a pronunciation of a name of the object, a pronunciation of a letter associated with the name of the object and/or a phoneme of the letter associated with the name of the object.

8. The apparatus of claim 1, wherein the at least one stamping structure has a plurality of selectable raised indicia, the apparatus further comprising a mechanism to select a single indicium for forming imprints of the selected indicium.

9. The apparatus of claim 1, wherein the at least one stamping structure comprises two separate stamping structures, each having a plurality of selectable raised indicia, the apparatus further comprising a mechanism to select one of the selectable raised indicia from each of the two separate stamping structures for forming simultaneous imprints of the two selected indicia.

10. The apparatus of claim 9, wherein one of the two selected indicia has the form of a letter of an alphabet and the other has the form of a picture of an object.

11. The apparatus of claim 9, wherein the audio includes a sound related to the two selected indicia.

12. The apparatus of claim 11, wherein the sound includes a song related to the two selected indicia.

13. A stamping apparatus comprising:
at least one stamping structure having a plurality of selectable raised indicia;
a mechanism to select at least one of the indicium to form an imprint of the at least one indicium on a sheet of material;
a processor;
a sound generator; and
a speaker operatively connected to the processor and the sound generator, wherein the processor and the sound generator are capable of producing audio related to the selected at least one indicium.

14. The apparatus of claim 13, wherein the at least one stamping structure comprises a first stamping structure having a first portion of the plurality of selectable raised indicia located sequentially thereon and a second stamping structure having a second portion of the plurality of selectable raised indicia located sequentially thereon, and wherein the mechanism is capable of selecting a first indicium from the first portion and a second indicium from the second portion.

15. The apparatus of claim 14, wherein the mechanism includes a mode switch to select a first mode wherein the mechanism is capable of selecting the first indicium from the first portion independently of the second indicium to form an imprint of the first indicium on the sheet of material.

16. The apparatus of claim 15, wherein the first indicium has the form of a letter of an alphabet and wherein the audio produced by the speaker includes a sound related to the letter.

17. The apparatus of claim 15, wherein the mode switch can select a second mode wherein the mechanism is capable of selecting the second indicium from the second portion independently of the first indicium to form an imprint of the second indicium on the sheet of material.

18. The apparatus of claim 17, wherein the second indicium has the form of a picture of an object and wherein the audio produced by the speaker includes a sound related to the object.

19. The apparatus of claim 17, wherein the mode switch can select a third mode wherein the mechanism is capable of simultaneously selecting the first and second indicia to form an imprint of the first and second indicia together on the sheet of material.

20. The apparatus of claim 19, wherein the first indicium has the form of a letter of an alphabet, second indicium has the form of a picture of an object and wherein the audio produced by the speaker includes a song related to the letter of the alphabet.

21. An apparatus of claim 13, wherein the at least one stamping structure comprises at least one belt having the plurality of selectable raised indicia located sequentially along the belt.

22. An apparatus of claim 14, wherein the mechanism rotates the at least one belt to position the selected at least one indicium at an orifice at a bottom portion of the apparatus.

23. A system for creating an imprint of at least one indicium on a sheet of material comprising:
a stamping apparatus comprising
at least one stamping structure having the at least one raised indicium configured to form the imprint of the indicium on the sheet of material,
a processor,
a sound generator coupled to the processor, and
a speaker operatively connected to the processor, wherein the sound generator and speaker are capable of producing audio related to the indicium;
at least one activity page comprising the sheet of material, wherein the sheet of material has at least one image printed thereon related to the indicium.

24. The system as in claim 23, wherein the at least one raised indicium has the form of a letter of the alphabet and the at least one image printed on the at least one activity page includes the letter of the alphabet.

25. The system of claim 24, wherein the at least one image includes at least one word starting with the letter of the alphabet.

26. The system of claim 24, wherein the at least one image includes at least one picture of an object having a name which starts with the letter of the alphabet.

27. The system as in claim 23, wherein the at least one activity page comprises a booklet.

28. The system as in claim 27, wherein the booklet includes blank pages.

29. The system as in claim 23, further comprising an ink pad.

30. A method of using a stamping apparatus comprising:
providing at least one stamping structure having
a plurality of selectable raised indicia,
a mechanism to select at least one of the indicium to form an imprint of the selected at least one indicium on a sheet of material,
a processor,
a sound generator, and
a speaker operatively connected to the processor and the sound generator, wherein the processor and sound generator are capable of producing audio; and
actuating the mechanism to select the at least one of the indicium, wherein actuating the mechanism produces the audio.

31. The method of claim 30, wherein actuating the mechanism comprises rotating a dial.

32. The method of claim 31, further comprising pressing the selected at least one indicium onto the sheet of material to form the imprint.

33. The method of claim 32, wherein pressing produces the audio.

34. An educational stamping apparatus comprising:
a.) a first belt having raised letters or numbers located sequentially along the belt;
b.) a second belt located adjacent to the first belt and containing raised pictures located sequentially along the belt, the second belt aligned with the first belt so that pictures associated with each letter or number remain adjacent as the belts rotate;
c.) a mechanism to rotate the belts so that selected letters and associated pictures are simultaneously moved to an orifice at a bottom portion of the apparatus; and
d.) a means to cause either other belt having a letter or the belt having a picture or both belts to depress so as to leave an imprint when stamped on a page.

35. The apparatus of claim 34, further comprising a speaker operatively connected to a processor and sound generator and capable of producing audio related to the selected letter or picture.
